(19) United States
(12) Patent Application Publication
(10) Pub. No.: US 2009/0087685 A1
(43) Pub. Date: Apr. 2, 2009

(54) MAGNETIC RECORDING MEDIUM

(75) Inventors: Tomohiro ICHIKAWA, Kanagawa (JP); Mikio OHNO, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 12/240,089

(22) Filed: Sep. 29, 2008

(30) Foreign Application Priority Data
Sep. 28, 2007 (JP) 2007-256602

(51) Int. Cl. G11B 5/68; G11B 5/70

(52) U.S. Cl. 428/840; 428/843

(57) ABSTRACT

The magnetic recording medium comprises a magnetic layer comprising a ferromagnetic powder and a binder on a nonmagnetic support. The magnetic layer has an average surface roughness Ra, measured by an atomic force microscope, ranging from 2.0 to 3.5 nm and an indentation hardness ranging from 0.49 GPa to 0.78 GPa, as well as further comprises a carbonic ester having a molecular weight of 360 to 460 that is denoted by general formula (1).

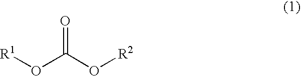

In general formula (1), R¹ denotes a saturated hydrocarbon group having a branched structure, and R² denotes a saturated hydrocarbon group having a linear structure with 14 to 20 carbon atoms.

### CROSS-REFERENCE TO RELATED APPLICATIONS

This application claims the benefit of priority under 35 USC 119 to Japanese Patent Application No. 2007-256602 filed on Sep. 28, 2007, which is expressly incorporated herein by reference in its entirety.

### BACKGROUND OF THE INVENTION

1. Field of the Invention

The present invention relates to a magnetic recording medium, and more particularly, to a magnetic recording medium having both excellent running durability and storage properties.

2. Discussion of the Background

In recent years, the need for high-density recording has increased, as has the need for magnetic recording media having good electromagnetic characteristics. However, when the smoothness of the surface of the magnetic layer is increased to achieve higher density recording, there are problems in that an increase in the frictional coefficient diminishes running properties and durability. Accordingly, lubricant is widely added to the magnetic layer in an attempt to reduce the frictional coefficient. Such attempt is disclosed in, for example, Japanese Unexamined Patent Publication (KOKAI) Heisei No. 7-138586, which is expressly incorporated herein by reference in its entirety.

In recent years, means for rapidly transmitting information at the terabyte level have undergone marked development, and it has become possible to transmit data and images comprising huge amounts of information. As these data transmission techniques have advanced, there has been demand for higher recording capacity in recording media for recording information. For example, magnetic tapes are employed in a variety of applications, such as audio tapes, video tapes, and computer tapes. In the field of data backup tapes, in particular, as the capacity of the hard disks being backed up has increased, data backup tapes with recording capacities of several 10 to 800 GB per winding have been commercialized. High-capacity backup tapes exceeding 1 TB have been proposed, and the realization of such high recording capacities is essential. In recording media exceeding 1 TB in capacity, an extremely high degree of surface smoothness is required. However, investigation by the present inventors has revealed that in magnetic recording media having a high degree of surface smoothness, even when running durability is ensured by adding abrasive as described in Japanese Unexamined Patent Publication (KOKAI) Heisei No. 7-138586, when the tape is left for an extended period (equal to or more than 24 hours, for example) in contact with the head after running, the tape sticks to the head, rendering running difficult when running is next attempted.

### SUMMARY OF THE INVENTION

An aspect of the present invention provides for a magnetic recording medium having both excellent running durability and storage properties.

An aspect of the present invention relates to a magnetic recording medium comprising a magnetic layer comprising a ferromagnetic powder and a binder on a nonmagnetic support, wherein the magnetic layer has an average surface roughness Ra, measured by an atomic force microscope, ranging from 2.0 to 3.5 nm and an indentation hardness ranging from 0.49 GPa to 0.78 GPa, as well as further comprises a carbonic ester having a molecular weight of 360 to 460 that is denoted by general formula (1).

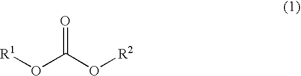

[In general formula (1), R¹ denotes a saturated hydrocarbon group having a branched structure, and R² denotes a saturated hydrocarbon group having a linear structure with 14 to 20 carbon atoms.]

In general formula (1), R¹ may denote a saturated hydrocarbon group having a branched structure at a β position.

In general formula (1), R¹ may denote 2-methylpropyl group, 2-methylbutyl group, or 2-ethylhexyl group, and R² may denote a saturated hydrocarbon group having a linear structure with 14 to 18 carbon atoms, such as tetradecyl group, hexadecyl group, and octadecyl group.

The above magnetic recording medium may have a nonmagnetic layer comprising a nonmagnetic powder and a binder between the nonmagnetic support and the magnetic layer, and the nonmagnetic layer may comprise the above carbonic ester.

The present invention can provide a magnetic recording medium having excellent surface smoothness and good running durability, in which renewed running is possible without the occurrence of running failure due to sticking after leaving the medium in contact with the head for a long time following running.

### DETAILED DESCRIPTIONS OF THE EMBODIMENTS

The following preferred specific embodiments are, therefore, to be construed as merely illustrative, and non-limiting to the remainder of the disclosure in any way whatsoever. In this regard, no attempt is made to show structural details of the present invention in more detail than is necessary for fundamental understanding of the present invention; the description taken with the drawings making apparent to those skilled in the art how several forms of the present invention may be embodied in practice.

The present invention relates to a magnetic recording medium comprising a magnetic layer comprising a ferromagnetic powder and a binder on a nonmagnetic support. In the magnetic recording medium of the present invention, the magnetic layer has an average surface roughness Ra, measured by an atomic force microscope, ranging from 2.0 to 3.5 nm and an indentation hardness ranging from 0.49 GPa to 0.78 GPa, as well as further comprises a carbonic ester having a molecular weight of 360 to 460 that is denoted by general formula (1).

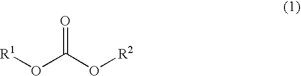

[In general formula (1), R¹ denotes a saturated hydrocarbon group having a branched structure, and R² denotes a saturated hydrocarbon group having a linear structure with 14 to 20 carbon atoms.]

The magnetic recording medium of the present invention can achieve excellent electromagnetic characteristics through a high degree of surface smoothness. However, as set forth above, the problem of deterioration in running properties (the occurrence of sticking) following storage may arise when the surface smoothness is increased.

By contrast, running durability can be achieved and sticking can be prevented in the present invention by employing the carbonic ester having a molecular weight of 360 to 460 that is denoted by general formula (1) above as a magnetic layer component and by setting the indentation hardness of the magnetic layer to within the above-stated range. The present inventors attribute the above to the following:
(1) High resistance to hydrolysis of the carbonic ester having the structure denoted by general formula (1) is thought to be the reason that the use of the carbonic ester enhances running durability and prevents sticking. Metal salts that are derived from medium components (such as fatty acid metal salts derived from lubricants) and that adhere to the head during running are a major cause of diminished running durability. By contrast, the carbonic ester having the above structure tends not to hydrolyze during running, which is thought to reduce the material adhering to the head and thus permit the achievement of good running durability.
(2) Seeping of suitable quantities of lubricant components onto the surface of the magnetic layer during storage is thought to effectively prevent adhesion to the head following storage. In the present invention, it is surmised that the quantity of the carbonic ester seeping onto the surface of the magnetic layer during storage can be suitably regulated through the hardness (indentation hardness) of the magnetic layer and the weight of the carbonic ester.

The magnetic recording medium of the present invention will be described in greater detail below.

### Carbonic Ester

The magnetic layer of the magnetic recording medium of the present invention comprises the carbonic ester having a molecular weight of 360 to 460 that is denoted by general formula (1). The carbonic ester is thought to maintain good storage properties in addition to enhancing running stability when employed as a lubricant component.

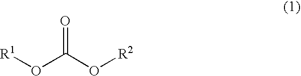

In general formula (1), R¹ denotes a saturated hydrocarbon group having a branched structure. With a carbonic ester denoted by general formula (1) in which both R¹ and R² denote linear carbonic esters, or both R¹ and R² denote carbonic esters with branched structures, it becomes difficult to achieve good running durability.

The branched structure in R¹ can be at either the a position or β position. However, from the perspective of achieving good running durability, the branched structure is preferably present at the β position in R¹. The saturated hydrocarbon denoted by R¹ comprises, for example, 4 to 10 carbon atoms, preferably 6 to 8. The saturated hydrocarbon group denoted by R¹ can comprise a substituent in a side chain. Examples of the substituent are: halogen atoms (such as a fluorine atom or chlorine atom).

Examples of saturated hydrocarbon groups that are desirable as R¹ are: 2-methylpropyl group, 2-methylbutyl group, and 2-ethylhexyl group.

In general formula (1), R² denotes a saturated hydrocarbon group having a linear structure with 14 to 20 carbon atoms. At fewer than 14 carbon atoms, lubricant tends to seep onto the surface of the magnetic layer during tape storage and during drive running, creating a problem in the form of sticking during drive running. Additionally, at more than 20 carbon atoms, the lubricant tends not to dissolve into the magnetic layer, tends to precipitate onto the surface of the magnetic layer, and tends to cause clogging during drive running. The number of carbon atoms is preferably 14 to 18, more preferably 16 to 18. In R², as in R¹, a substituent may be present in a side chain. Examples of saturated hydrocarbon groups that are desirable as R² are: tetradecyl group, pentadecyl group, hexadecyl group, heptadecyl group, and octadecyl group, with tetradecyl group, hexadecyl group, and octadecyl group being preferred.

The molecular weight of the carbonic ester ranges from 360 to 460. When the molecular weight is less than 360 and the medium and the head are left standing for an extended period following running, surface tension causes the medium to stick to the head due to the tendency of the carbonic ester to seep out onto the medium surface. Conversely, when the molecular weight exceeds 460, precipitate tends to form on the surface of the medium during storage.

The carbonic ester can be synthesized by known methods. An example of a synthesis method is to react a chloroformic ester with an alcohol comprising the above-described hydrocarbon group. Specific suitable examples of the chloroformic ester starting material of this synthesis reaction are: 2-methylpropyl groups, 2-methylbutyl groups, and 2-ethylhexyl groups. The carbonic esters may be available as a commercial product.

The content of the carbonic ester in the magnetic layer is, for example, 0.1 to 10 weight percent, preferably 0.3 to 6 weight percent, and more preferably, 0.5 to 3 weight percent. Just one type of carbonic ester may be employed, or two or more types may be mixed for use.

The carbonic ester may also be incorporated into a nonmagnetic layer. Incorporation of the carbonic ester into the nonmagnetic layer can regulate the amount of carbonic ester in the nonmagnetic layer that gradually migrates to the magnetic layer side and seeps out onto the surface during running and storage. This is advantageous to maintaining good running durability and storage properties. In this case, for example, it is possible to control the quantity of the carbonic ester present on the surface of the magnetic layer during running and storage by employing esters of different boiling points and polarity in the nonmagnetic layer and magnetic layer to control seepage onto the surface, by regulating the quantity of surfactant to enhance coating stability, and by increasing the quantity of carbonic ester added to the nonmagnetic layer. The content of the carbonic ester in the nonmagnetic layer is, for example, 0.1 to 10 weight percent, preferably 0.3 to 6 weight percent, and more preferably, 0.5 to 3 weight percent.

### Indentation Hardness of the Magnetic Layer

The indentation hardness of the magnetic layer in the magnetic recording medium of the present invention ranges from 0.49 to 0.78 GPa (approximately 50 to 80 kg/mm²). The indentation hardness of the magnetic layer in the present invention is a value measured with a microindentation tester, the ENT-1100a from Elionix Co., by pressing a diamond indenter into the surface of the magnetic layer with a load of 6 mgf in an environment of 25° C. When the indentation hardness of the magnetic layer is less than 0.49 GPa, lubricant seeps from the layer out onto the surface due to contact with the head, and ends up causing sticking during renewed running. The present inventors surmise that compression of the magnetic layer and nonmagnetic layer causes the lubricant within the layers to seep out onto the surface. When the indentation hardness of the magnetic layer exceeds 0.78 GPa, head contact deteriorates and it becomes difficult to achieve good running durability. The indentation hardness of the magnetic layer preferably ranges from 0.49 to 0.69 GPa (approximately 50 to 70 kg/mm²), more preferably from 0.59 to 0.69 GPa (approximately 60 to 70 kg/mm²).

A variety of methods can be employed to adjust the indentation hardness of the magnetic layer to within the above-stated range. For example, methods such as the following can be employed: the three-component ratio (polyvinyl chloride, urethane, and curing agent) of the binder resin in the magnetic layer can be varied; the P/B ratio (the ratio of inorganic powder such as magnetic material and binder resin) can be varied; resin in which a polar functional group has been incorporated can be employed as the binder to increase the dispersibility of the ferromagnetic powder; and the modulus of elasticity or glass transition point (Tg) of the binder resin can be raised. The quantity of lubricant can be increased to plasticize the binder and increase calendering moldability, thereby controlling the indentation hardness. The indentation hardness can also be adjusted by varying the type and/or quantity of kneading solvent when preparing the magnetic layer coating liquid to alter the degree of kneading. Still further, methods such as varying the calendering conditions (temperature, pressure, hardness of the calendering rolls, and the like) and introducing metal calender rolls can be used to conduct stronger calendering and adjust the indentation hardness of the magnetic layer.

### Magnetic Layer Surface Roughness

In the magnetic recording medium of the present invention, the surface roughness of the magnetic layer ranges from 2.0 to 3.5 nm as an average surface roughness Ra measured by an atomic force microscope. When the surface roughness Ra is less than 2.0 nm, stable running becomes difficult, and when 3.5 nm is exceeded, it becomes difficult to achieve good error rate. The surface roughness preferably ranges from 2.0 to 3.0 nm, more preferably from 2.5 to 3.0 nm. The surface roughness Ra can be obtained by measuring the Ra of a 40 micrometer square on the surface of the magnetic layer with an SPI3800N made by SII NanoTechnology, Inc., for example.

Various means can be employed to achieve an average surface roughness in the magnetic layer that falls within the above-stated range. For example, the number of aggregate particles of magnetic material potentially becoming protrusions can be adjusted by means of the quantity of polar functional groups in the binder resin, the quantity of binder resin, and/or the period of dispersion in the disperser to increase the smoothness of the surface of the magnetic layer. Further, the quantity of carbon black and abrasive employed in the magnetic layer that can potentially become protrusions, as well as the dispersion method, can be adjusted to control the surface roughness of the magnetic layer. Still further, in the same manner as when adjusting the indentation hardness of the magnetic layer, adjustment can be made by varying the calendering conditions (temperature, pressure, calender roll hardness, and the like).

### Magnetic Layer

The magnetic layer in the magnetic recording medium of the present invention will be described below.

Ferromagnetic metal powder and hexagonal ferrite powder can be employed as the ferromagnetic powder in the magnetic layer. Details thereof will be described below. However, the ferromagnetic powder employed in the present invention is not limited to the ferromagnetic metal powder and hexagonal ferrite powder. For example, nitriding iron powders and the like may be employed.

(i) Ferromagnetic Metal Powder

The ferromagnetic metal powder employed in the magnetic layer is not specifically limited, but preferably a ferromagnetic metal power comprised primarily of α-Fe. In addition to prescribed atoms, the following atoms can be contained in the ferromagnetic metal powder: Al, Si, S, Sc, Ca, Ti, V, Cr, Cu, Y, Mo, Rh, Pd, Ag, Sn, Sb, Te, Ba, Ta, W, Re, Au, Hg, Pb, Bi, La, Ce, Pr, Nd, P, Co, Mn, Zn, Ni, Sr, B and the like. Particularly, incorporation of at least one of the following in addition to α-Fe is desirable: Al, Si, Ca, Y, Ba, La, Nd, Co, Ni, and B. Incorporation of at least one selected from the group consisting of Co, Y and Al is particularly preferred. The Co content preferably ranges from 0 to 40 atom percent, more preferably from 15 to 35 atom percent, further preferably from 20 to 35 atom percent with respect to Fe. The content of Y preferably ranges from 1.5 to 12 atom percent, more preferably from 3 to 10 atom percent, further preferably from 4 to 9 atom percent with respect to Fe. The Al content preferably ranges from 1.5 to 12 atom percent, more preferably from 3 to 10 atom percent, further preferably from 4 to 9 atom percent with respect to Fe.

These ferromagnetic metal powders may be pretreated prior to dispersion with dispersing agents, lubricants, surfactants, antistatic agents, and the like, described further below. Specific examples are described in Japanese Examined Patent Publication (KOKOKU) Showa Nos. 44-14090, 45-18372, 47-22062, 47-22513, 46-28466, 46-38755, 47-4286, 47-12422, 47-17284, 47-18509, 47-18573, 39-10307, and 46-39639; and U.S. Pat. Nos. 3,026,215, 3,031,341, 3,100,194, 3,242,005, and 3,389,014, which are expressly incorporated herein by reference in their entirety.

The ferromagnetic metal powder may contain a small quantity of hydroxide or oxide. Ferromagnetic metal powders obtained by known manufacturing methods may be employed. The following are examples of methods of manufacturing ferromagnetic metal powders: methods of reduction with compound organic acid salts (chiefly oxalates) and reducing gases such as hydrogen; methods of reducing iron oxide with a reducing gas such as hydrogen to obtain Fe or Fe—Co particles or the like; methods of thermal decomposition of metal carbonyl compounds; methods of reduction by addition of a reducing agent such as sodium boron hydride, hypophosphite, or hydrazine to an aqueous solution of ferromagnetic metal; and methods of obtaining powder by vaporizing a metal in a low-pressure inert gas. Any one from among the known method of slow oxidation, that is, immersing the ferromagnetic metal powder thus obtained in an organic solvent and drying it; the method of immersing the ferromagnetic metal powder in an organic solvent, feeding in an oxygen-containing gas to form a surface oxide film, and then conducting drying; and the method of adjusting the partial pressures of oxygen gas and an inert gas without employing an organic solvent to form a surface oxide film, may be employed.

The specific surface area by BET method of the ferromagnetic metal powder employed in the magnetic layer is preferably 45 to 100 m²/g, more preferably 50 to 80 m²/g. At 45 m²/g and above, low noise is achieved. At 100 m²/g and below, good surface properties are achieved. The crystallite size of the ferromagnetic metal powder is preferably 80 to 180 Angstroms, more preferably 100 to 180 Angstroms, and still more preferably, 110 to 175 Angstroms. The major axis length of the ferromagnetic metal powder is preferably equal to or greater than 0.01 micrometer and equal to or less than 0.15 micrometer, more preferably equal to or greater than 0.02 micrometer and equal to or less than 0.15 micrometer, and still more preferably, equal to or greater than 0.03 micrometer and equal to or less than 0.12 micrometer. The acicular ratio of the ferromagnetic metal powder is preferably equal to or greater than 3 and equal to or less than 15, more preferably equal to or greater than 5 and equal to or less than 12. The σₛ of the ferromagnetic metal powder is preferably 100 to 180 A·m²/kg, more preferably 110 to 170 A·m²/kg, and still more preferably, 125 to 160 A·m²/kg. The coercivity of the ferromagnetic powder is preferably 2,000 to 3,500 Oe, approximately 160 to 280 kA/m, more preferably 2,200 to 3,000 Oe, approximately 176 to 240 kA/m.

The moisture content of the ferromagnetic metal powder is desirably 0.01 to 2 percent. The moisture content of the ferromagnetic metal powder is desirably optimized based on the type of binder. The pH of the ferromagnetic metal powder is desirably optimized depending on what is combined with the binder. A range of 4 to 12 can be established, with 6 to 10 being preferred. As needed, the ferromagnetic metal powder can be surface treated with Al, Si, P, or an oxide thereof. The quantity can be set to 0.1 to 10 weight percent of the ferromagnetic metal powder. When applying a surface treatment, the quantity of a lubricant such as a fatty acid that is adsorbed is desirably not greater than 100 mg/m². The ferromagnetic metal powder will sometimes contain inorganic ions such as soluble Na, Ca, Fe, Ni, or Sr. These are desirably substantially not present, but seldom affect characteristics at equal to or less than 200 ppm. The ferromagnetic metal powder employed in the present invention desirably has few voids; the level is preferably equal to or less than 20 volume percent, more preferably equal to or less than 5 volume percent. As stated above, so long as the particle size characteristics are satisfied, the ferromagnetic metal powder may be acicular, rice grain-shaped, or spindle-shaped. The SFD of the ferromagnetic metal powder itself is desirably low, with equal to or less than 0.8 being preferred. The Hc distribution of the ferromagnetic metal powder is desirably kept low. When the SFD is equal to or lower than 0.8, good electromagnetic characteristics are achieved, output is high, and magnetic inversion is sharp, with little peak shifting, in a manner suited to high-density digital magnetic recording. To keep the Hc low, the methods of improving the particle size distribution of goethite in the ferromagnetic metal powder and preventing sintering may be employed.

(ii) Hexagonal Ferrite Powder

Examples of hexagonal ferrite powders are barium ferrite, strontium ferrite, lead ferrite, calcium ferrite, and various substitution products thereof such as Co substitution products. Specific examples are magnetoplumbite-type barium ferrite and strontium ferrite; magnetoplumbite-type ferrite in which the particle surfaces are covered with spinels; and magnetoplumbite-type barium ferrite, strontium ferrite, and the like partly comprising a spinel phase. The following may be incorporated into the hexagonal ferrite powder in addition to the prescribed atoms: Al, Si, S, Sc, Ti, V, Cr, Cu, Y, Mo, Rh, Pd, Ag, Sn, Sb, Te, Ba, Ta, W, Re, Au, Hg, Pb, Bi, La, Ce, Pr, Nd, P, Co, Mn, Zn, Ni, Sr, B, Ge, Nb and the like. Compounds to which elements such as Co—Zn, Co—Ti, Co—Ti—Zr, Co—Ti—Zn, Ni—Ti—Zn, Nb—Zn—Co, Sb—Zn—Co, and Nb—Zn have been added may generally also be employed. They may comprise specific impurities depending on the starting materials and manufacturing methods employed.

When the length of the signal recording region approaches the size of the magnetic material contained in the magnetic layer, it becomes impossible to create a distinct magnetization transition state, essentially precluding recording. Thus, the shorter the recording wavelength becomes, the smaller the magnetic material should be. In the present invention, to achieve good recording in the short-wavelength region, the use of hexagonal ferrite powder having a mean plate diameter falling within a range of 10 to 40 nm is preferable, a range of 15 to 30 nm is more preferable, and a range of 20 to 25 nm is of still greater preference.

An average plate ratio [arithmetic average of (plate diameter/plate thickness)] preferably ranges from 1 to 15, more preferably 1 to 7. When the average plate diameter ranges from 1 to 15, adequate orientation can be achieved while maintaining high filling property, as well as increased noise due to stacking between particles can be suppressed. The specific surface area by BET method (S_{BET}) within the above particle size range is preferably equal to or higher than 40 m²/g, more preferably 40 to 200 m²/g, and particularly preferably, 60 to 100 m²/g.

Narrow distributions of particle plate diameter and plate thickness of the hexagonal ferrite powder are normally good. About 500 particles can be randomly measured in a transmission electron microscope (TEM) photograph of particles to measure the particle plate diameter and plate thickness. The distributions of particle plate diameter and plate thickness are often not a normal distribution. However, when expressed as the standard deviation to the average size, a/average size may be 0.1 to 1.0. The particle producing reaction system is rendered as uniform as possible and the particles produced are subjected to a distribution-enhancing treatment to achieve a narrow particle size distribution. For example, methods such as selectively dissolving ultrafine particles in an acid solution by dissolution are known.

A coercivity (Hc) of the hexagonal ferrite powder of about 143.3 to 318.5 kA/m (approximately 1800 to 4,000 Oe) can normally be achieved. The coercivity (Hc) of the hexagonal ferrite powder preferably ranges from 159.2 to 238.9 kA/m (approximately 2,000 to 3,000 Oe), more preferably 191.0 to 214.9 kA/m (approximately 2,200 to 2,800 Oe). The coercivity (Hc) can be controlled by particle size (plate diameter and plate thickness), the types and quantities of elements contained, substitution sites of the element, the particle producing reaction conditions, and the like.

The saturation magnetization (σₛ) of the hexagonal ferrite powder can be 30 to 80 A·m²/kg (30 to 80 emu/g). The higher saturation magnetization (σₛ) is preferred, however, it tends to decrease with decreasing particle size. Known methods of improving saturation magnetization (σₛ) are combining spinel ferrite with magnetoplumbite ferrite, selection of the type and quantity of elements incorporated, and the like. It is also possible to employ W-type hexagonal ferrite. When dispersing the hexagonal ferrite powder, the surface of the hexagonal ferrite powder can be processed with a substance suited to a dispersion medium and a polymer. Both organic and inorganic compounds can be employed as surface treatment agents. Examples of the principal compounds are oxides and hydroxides of Si, Al, P, and the like; various silane coupling agents; and various titanium coupling agents. The quantity of surface treatment agent added can range from 0.1 to 10 weight percent relative to the weight of the hexagonal ferrite powder. The pH of the hexagonal ferrite powder is also important to dispersion. A pH of about 4 to 12 is usually optimum for the dispersion medium and polymer. From the perspective of the chemical stability and storage properties of the medium, a pH of about 6 to 11 can be selected. Moisture contained in the hexagonal ferrite powder also affects dispersion. There is an optimum level for the dispersion medium and polymer, usually selected from the range of 0.01 to 2.0 weight percent.

Methods of manufacturing the hexagonal ferrite powder include: (1) a vitrified crystallization method consisting of mixing into a desired ferrite composition barium oxide, iron oxide, and a metal oxide substituting for iron with a glass forming substance such as boron oxide; melting the mixture; rapidly cooling the mixture to obtain an amorphous material; reheating the amorphous material; and refining and comminuting the product to obtain a barium ferrite crystal powder; (2) a hydrothermal reaction method consisting of neutralizing a barium ferrite composition metal salt solution with an alkali; removing the by-product; heating the liquid phase to equal to or greater than 100° C.; and washing, drying, and comminuting the product to obtain barium ferrite crystal powder; and (3) a coprecipitation method consisting of neutralizing a barium ferrite composition metal salt solution with an alkali; removing the by-product; drying the product and processing it at equal to or less than 1,100° C.; and comminuting the product to obtain barium ferrite crystal powder. Any manufacturing method can be selected in the present invention. As needed, the hexagonal ferrite powder can be surface treated with Al, Si, P, or an oxide thereof. The quantity can be set to 0.1 to 10 weight percent of the hexagonal ferrite powder. When applying a surface treatment, the quantity of a lubricant such as a fatty acid that is adsorbed is desirably not greater than 100 mg/m². The hexagonal ferrite powder will sometimes contain inorganic ions such as soluble Na, Ca, Fe, Ni, or Sr. These are desirably substantially not present, but seldom affect characteristics at equal to or less than 200 ppm.

Known techniques regarding binders, lubricants, dispersion agents, additives, solvents, dispersion methods and the like for magnetic layer, nonmagnetic layer and backcoat layer can be suitably applied. In particular, known techniques regarding the quantity and types of binders, and quantity added and types of additives and dispersion agents can be applied.

Conventionally known thermoplastic resins, thermosetting resins, reactive resins and mixtures thereof may be employed as binders used. The thermoplastic resins suitable for use have a glass transition temperature of −100 to 150° C., a number average molecular weight of 1,000 to 200,000, preferably from 10,000 to 100,000, and have a degree of polymerization of about 50 to 1,000.

Examples thereof are polymers and copolymers comprising structural units in the form of vinyl chloride, vinyl acetate, vinyl alcohol, maleic acid, acrylic acid, acrylic acid esters, vinylidene chloride, acrylonitrile, methacrylic acid, methacrylic acid esters, styrene, butadiene, ethylene, vinyl butyral, vinyl acetal, and vinyl ether; polyurethane resins; and various rubber resins. Further, examples of thermosetting resins and reactive resins are phenol resins, epoxy resins, polyurethane cured resins, urea resins, melamine resins, alkyd resins, acrylic reactive resins, formaldehyde resins, silicone resins, epoxy polyamide resins, mixtures of polyester resins and isocyanate prepolymers, mixtures of polyester polyols and polyisocyanates, and mixtures of polyurethane and polyisocyanates. These resins are described in detail in Handbook of Plastics published by Asakura Shoten, which is expressly incorporated herein by reference in its entirety. It is also possible to employ known electron beam-cured resins in each layer. Examples and manufacturing methods of such resins are described in Japanese Unexamined Patent Publication (KOKAI) Showa No. 62-256219, which is expressly incorporated herein by reference in its entirety. The above-listed resins may be used singly or in combination. Preferred resins are combinations of polyurethane resin and at least one member selected from the group consisting of vinyl chloride resin, vinyl chloride-vinyl acetate copolymers, vinyl chloride-vinyl acetate-vinyl alcohol copolymers, and vinyl chloride-vinyl acetate-maleic anhydride copolymers, as well as combinations of the same with polyisocyanate. Among these, vinyl chloride binder and polyurethane binder are preferred.

As the polyurethane, polyester-urethane, polyether-urethane, polycarbonate-urethane, polyetherester-urethane, acrylic polyurethane can be employed. The above binders can have high compatibility with the above-described carbonic ester to control the surface lubricant quantity to an optimal range. The polar groups incorporated in the binder are preferably sulfonate, sulfamate, sulfobetain, phosphate, phosphonate and the like. The content of the polar group that may be incorporated in the binder preferably ranges from 1×10⁵ eq/g to 2×10⁻⁴ eq/g. The above-described binders can be synthesized by known methods, or can be obtained by incorporating a suitable amount of polar groups into a commercial product.

Polyurethane can be employed as a binder with vinyl chloride resin. However, when a small amount of dechlorination causes head corrosion, it is also possible to employ polyurethane alone, or employ polyurethane and isocyanate alone. When polyurethane is employed, a glass transition temperature of −50 to 150° C., preferably 0 to 100° C., an elongation at break of 100 to 2,000 percent, a stress at break of 0.05 to 10 kg/mm² (approximately 0.49 to 98 MPa), and a yield point of 0.05 to 10 kg/mm² (approximately 0.49 to 98 MPa) are desirable.

Examples of polyisocyanates are tolylene diisocyanate, 4,4′-diphenylmethane diisocyanate, hexamethylene diisocyanate, xylylene diisocyanate, napthylene-1,5-diisocyanate, o-toluidine diisocyanate, isophorone diisocyanate, triphenylmethane triisocyanate, and other isocyanates; products of these isocyanates and polyalcohols; polyisocyanates produced by condensation of isocyanates; and the like. These isocyanates are commercially available under the following trade names, for example: Coronate L, Coronate HL, Coronate 2030, Coronate 2031, Millionate MR and Millionate MTL manufactured by Nippon Polyurethane Industry Co. Ltd.; Takenate D-102, Takenate D-110N, Takenate D-200 and Takenate D-202 manufactured by Takeda Chemical Industries Co., Ltd.; and Desmodule L, Desmodule IL, Desmodule N and Desmodule HL manufactured by Sumitomo Bayer Co., Ltd. They can be used in each layer singly or in combinations of two or more by exploiting differences in curing reactivity.

The quantity of binder in the magnetic layer is preferably 10 to 25 weight parts per 100 weight parts of ferromagnetic powder, including curing agent. When the magnetic recording medium of the present invention comprises a nonmagnetic layer between the magnetic layer and the nonmagnetic support, the quantity of binder in the nonmagnetic layer is preferably greater than that in the magnetic layer. Specifically, the quantity of binder in the nonmagnetic layer is preferably 25 to 40 weight parts per 100 weight parts of nonmagnetic powder.

The binder employed in the nonmagnetic layer preferably has a structure comprising strong polar groups such as SO₃Na and numerous aromatic rings in the skeleton. This increases compatibility with the carbonic ester and the nonmagnetic layer binder, permitting the stable presence of a large amount of carbonic ester in the nonmagnetic layer. Excessive compatibility between the carbonic ester and the binder, where they completely dissolve into each other at the molecular level, is undesirable in that the carbonic ester becomes incapable of migrating into the magnet layer.

Additives may be added to the magnetic layer and nonmagnetic layer as needed. Examples of such additives are: abrasives, lubricants, dispersing agents, dispersing adjuvants, antifungal agents, antistatic agents, oxidation inhibitors, solvents, and carbon black. The lubricant components indicated below, for example, can be employed with the above-described carbonic ester as lubricant components of the magnetic layer and nonmagnetic layer. To reduce the coefficient of friction and prevent sintering, stearic acid and stearic acid amide are suitably incorporated as lubricants. The quantity of the lubricant employed with the carbonic ester is preferably 0.5 to 3 weight parts, more preferably 0.5 to 1.5 weight parts, per 100 weight parts of ferromagnetic or nonmagnetic powder. Lubricant components having ester bonds are desirably not incorporated because they tend to hydrolyze.

Examples of additives are: molybdenum disulfide, tungsten disulfide, graphite, boron nitride, graphite fluoride, silicone oil, polar group-comprising silicone, fatty acid-modified silicone, fluorosilicone, fluoroalcohols, fluoroesters, polyolefin, polyglycol, polyphenyl ether, phenyl phosphonic acid, benzyl phosphonic acid, phenethyl phosphonic acid, α-methylbenzylphosphonic acid, 1-methyl-1-phenethylphosphonic acid, diphenylmethylphosphonic acid, biphenylphosphonic acid, benzylphenylphosphonic acid, α-cumylphosphonic acid, toluylphosphonic acid, xylylphosphonic acid, ethylphenylphosphonic acid, cumenylphosphonic acid, propylphenylphosphonic acid, butylphenylphosphonic acid, heptylphenylphosphonic acid, octylphenylphosphonic acid, nonylphenylphosphonic acid, other aromatic ring-comprising organic phosphonic acids, alkali metal salts thereof, octylphosphonic acid, 2-ethylhexylphosphonic acid, isooctylphosphonic acid, isononylphosphonic acid, isodecylphosphonic acid, isoundecylphosphonic acid, isododecylphosphonic acid, isohexadecylphosphonic acid, isooctadecylphosphonic acid, isoeicosylphosphonic acid, other alkyl phosphonoic acid, alkali metal salts thereof, phenyl phosphoric acid, benzyl phosphoric acid, phenethyl phosphoric acid, α-methylbenzylphosphoric acid, 1-methyl-1-phenethylphosphoric acid, diphenylmethylphosphoric acid, diphenyl phosphoric acid, benzylphenyl phosphoric acid, α-cumyl phosphoric acid, toluyl phosphoric acid, xylyl phosphoric acid, ethylphenyl phosphoric acid, cumenyl phosphoric acid, propylphenyl phosphoric acid, butylphenyl phosphoric acid, heptylphenyl phosphoric acid, octylphenyl phosphoric acid, nonylphenyl phosphoric acid, other aromatic phosphoric esters, alkali metal salts thereof, octyl phosphoric acid, 2-ethylhexylphosphoric acid, isooctyl phosphoric acid, isononyl phosphoric acid, isodecyl phosphoric acid, isoundecyl phosphoric acid, isododecyl phosphoric acid, isohexadecyl phosphoric acid, isooctyldecyl phosphoric acid, isoeicosyl phosphoric acid, other alkyl ester phosphoric acids, alkali metal salts thereof, alkylsulfonic acid ester, alkali metal salts thereof, fluorine-containing alkyl sulfuric acid esters, alkali metal salts thereof, lauric acid, myristic acid, palmitic acid, stearic acid, behenic acid, oleic acid, linolic acid, linoleic acid, elaidic acid, erucic acid, other monobasic fatty acids comprising 10 to 24 carbon atoms (which may contain an unsaturated bond or be branched), metal salts thereof, butyl stearate, octyl stearate, amyl stearate, isooctyl stearate, octyl myristate, butyl laurate, butoxyethyl stearate, anhydrosorbitan monostearate, anhydrosorbitan tristearate, other monofatty esters, difatty esters, or polyfatty esters comprising a monobasic fatty acid having 10 to 24 carbon atoms (which may contain an unsaturated bond or be branched) and any one from among a monohydric, dihydric, trihydric, tetrahydric, pentahydric or hexahydric alcohol having 2 to 22 carbon atoms (which may contain an unsaturated bond or be branched), alkoxyalcohol having 12 to 22 carbon atoms (which may contain an unsaturated bond or be branched) or a monoalkyl ether of an alkylene oxide polymer, fatty acid amides with 2 to 22 carbon atoms, and aliphatic amines with 8 to 22 carbon atoms. Compounds having aralkyl groups, aryl groups, or alkyl groups substituted with groups other than hydrocarbon groups, such as nitro groups, F, Cl, Br, CF₃, CCl₃, CBr₃, and other halogen-containing hydrocarbons in addition to the above hydrocarbon groups, may also be employed.

It is also possible to employ nonionic surfactants such as alkylene oxide-based surfactants, glycerin-based surfactants, glycidol-based surfactants and alkylphenolethylene oxide adducts; cationic surfactants such as cyclic amines, ester amides, quaternary ammonium salts, hydantoin derivatives, heterocycles, phosphoniums, and sulfoniums; anionic surfactants comprising acid groups, such as carboxylic acid, sulfonic acid, phosphoric acid, sulfuric ester groups, and phosphoric ester groups; and ampholytic surfactants such as amino acids, amino sulfonic acids, sulfuric or phosphoric esters of amino alcohols, and alkyl betaines. Details of these surfactants are described in A Guide to Surfactants (published by Sangyo Tosho K.K.), which is expressly incorporated herein by reference in its entirety.

These lubricants, antistatic agents and the like need not be 100 percent pure and may contain impurities, such as isomers, unreacted material, by-products, decomposition products, and oxides in addition to the main components. These impurities are preferably comprised equal to or less than 30 weight percent, and more preferably equal to or less than 10 weight percent.

Specific examples of these additives are: NAA-102, hydrogenated castor oil fatty acid, NAA-42, Cation SA, Nymeen L-201, Nonion E-208, Anon BF and Anon LG manufactured by NOF Corporation; FAL-205 and FAL-123 manufactured by Takemoto Oil & Fat Co.,Ltd.; NJLUB OL manufactured by New Japan Chemical Co.Ltd.; TA-3 manufactured by Shin-Etsu Chemical Co.Ltd.; Armide P and Duomine TDO manufactured by Lion Corporation; BA-41G manufactured by Nisshin OilliO, Ltd.; and Profan 2012E, Newpole PE61 and Ionet MS-400 manufactured by Sanyo Chemical Industries, Ltd.

Carbon black may be added to the magnetic layer as needed. Examples of types of carbon black that are suitable for use in the magnetic layer are: furnace black for rubber, thermal for rubber, black for coloring, and acetylene black. It is preferable that the specific surface area is 5 to 500 m²/g, the DBP oil absorption capacity is 10 to 400 ml/100 g, the particle diameter is 5 to 300 nm, the pH is 2 to 10, the moisture content is 0.1 to 10 percent, and the tap density is 0.1 to 1 g/ml.

Specific examples of types of carbon black employed are: BLACK PEARLS 2000, 1300, 1000, 900, 905, 800, 700 and VULCAN XC-72 from Cabot Corporation; #80, #60, #55, #50 and #35 manufactured by Asahi Carbon Co., Ltd.; #2400B, #2300, #900, #1000, #30, #40 and #10B from Mitsubishi Chemical Corporation; CONDUCTEX SC, RAVEN 150, 50, 40, 15 and RAVEN MT-P from Columbia Carbon Co., Ltd.; and Ketjen Black EC from Ketjen Black International Co., Ltd. The carbon black employed may be surface-treated with a dispersant or grafted with resin, or have a partially graphite-treated surface. The carbon black may be dispersed in advance into the binder prior to addition to the magnetic coating liquid. These carbon blacks may be used singly or in combination. When employing carbon black, the quantity preferably ranges from 0.1 to 30 weight percent with respect to the weight of the magnetic material. In the magnetic layer, carbon black can work to prevent static, reduce the coefficient of friction, impart light-blocking properties, enhance film strength, and the like; the properties vary with the type of carbon black employed. Accordingly, the type, quantity, and combination of carbon blacks employed in the present invention may be determined separately for the magnetic layer and the nonmagnetic layer based on the objective and the various characteristics stated above, such as particle size, oil absorption capacity, electrical conductivity, and pH, and be optimized for each layer. For example, the Carbon Black Handbook compiled by the Carbon Black Association, which is expressly incorporated herein by reference in its entirety, may be consulted for types of carbon black suitable for use in the magnetic layer.

Known materials chiefly having a Mohs' hardness of equal to or greater than 6 may be employed either singly or in combination as abrasives. These include: α-alumina with an α-conversion rate of equal to or greater than 90 percent, β-alumina, silicon carbide, chromium oxide, cerium oxide, α-iron oxide, corundum, synthetic diamond, silicon nitride, titanium carbide, titanium oxide, silicon dioxide, and boron nitride. Complexes of these abrasives (obtained by surface treating one abrasive with another) may also be employed. There are cases in which compounds or elements other than the primary compound are contained in these abrasives; the effect does not change so long as the content of the primary compound is equal to or greater than 90 percent. The particle size of the abrasive is preferably 0.01 to 2 micrometers. To enhance electromagnetic characteristics, a narrow particle size distribution is desirable. Abrasives of differing particle size may be incorporated as needed to improve durability; the same effect can be achieved with a single abrasive as with a wide particle size distribution. It is preferable that the tap density is 0.3 to 2 g/cc, the moisture content is 0.1 to 5 percent, the pH is 2 to 11, and the specific surface area is 1 to 30 m²/g. The shape of the abrasive employed may be acicular, spherical, cubic, plate-shaped or the like. However, a shape comprising an angular portion is desirable due to high abrasiveness. Specific examples are AKP-12, AKP-15, AKP-20, AKP-30, AKP-50, HIT-20, HIT-30, HIT-55, HIT-60, HIT-70, HIT-80, and HIT-100 made by Sumitomo Chemical Co.,Ltd.; ERC-DBM, HP-DBM, and HPS-DBM made by Reynolds Corp.; WA10000 made by Fujimi Abrasive Corp.; UB20 made by Uemura Kogyo Corp.; G-5, Chromex U2, and Chromex U1 made by Nippon Chemical Industrial Co., Ltd.; TF100 and TF140 made by Toda Kogyo Corp.; Beta Random Ultrafine made by Ibiden Co., Ltd.; and B-3 made by Showa Kogyo Co., Ltd. These abrasives may be added as needed to the nonmagnetic layer. Addition of abrasives to the nonmagnetic layer can be done to control surface shape, control how the abrasive protrudes, and the like. The particle size and quantity of the abrasives added to the magnetic layer and nonmagnetic layer should be set to optimal values.

Known organic solvents can be used in any ratio. Examples are ketones such as acetone, methyl ethyl ketone, methyl isobutyl ketone, diisobutyl ketone, cyclohexanone, isophorone, and tetrahydrofuran; alcohols such as methanol, ethanol, propanol, butanol, isobutyl alcohol, isopropyl alcohol, and methylcyclohexanol; esters such as methyl acetate, butyl acetate, isobutyl acetate, isopropyl acetate, ethyl lactate, and glycol acetate; glycol ethers such as glycol dimethyl ether, glycol monoethyl ether, and dioxane; aromatic hydrocarbons such as benzene, toluene, xylene, cresol, and chlorobenzene; chlorinated hydrocarbons such as methylene chloride, ethylene chloride, carbon tetrachloride, chloroform, ethylene chlorohydrin, and dichlorobenzene; N,N-dimethylformamide; and hexane.

These organic solvents need not be 100 weight percent pure and may contain impurities such as isomers, unreacted materials, by-products, decomposition products, oxides and moisture in addition to the main components. The content of these impurities is preferably equal to or less than 30 weight percent, more preferably equal to or less than 10 weight percent. Preferably the same type of organic solvent is employed in the magnetic layer and in the nonmagnetic layer. However, the amount added may be varied. The stability of coating is increased by using a solvent with a high surface tension (such as cyclohexanone or dioxane) in the nonmagnetic layer. Specifically, it is important that the arithmetic mean value of the magnetic layer solvent composition be not less than the arithmetic mean value of the nonmagnetic layer solvent composition. To improve dispersion properties, a solvent having a somewhat strong polarity is desirable. It is desirable that solvents having a dielectric constant equal to or higher than 15 are comprised equal to or higher than 50 percent of the solvent composition. Further, the dissolution parameter is desirably 8 to 11.

The types and quantities of dispersing agents, lubricants, and surfactants employed in the magnetic layer may differ from those employed in the nonmagnetic layer, described further below, in the present invention. For example (the present invention not being limited to the embodiments given herein), a dispersing agent usually has the property of adsorbing or bonding by means of a polar group. In the magnetic layer, the dispersing agent adsorbs or bonds by means of the polar group primarily to the surface of the ferromagnetic metal powder, and in the nonmagnetic layer, primarily to the surface of the nonmagnetic powder. It is surmised that once an organic phosphorus compound has adsorbed or bonded, it tends not to dislodge readily from the surface of a metal, metal compound, or the like. Accordingly, the surface of a ferromagnetic metal powder or the surface of a nonmagnetic powder becomes covered with the alkyl group, aromatic groups, and the like. This enhances the compatibility of the ferromagnetic metal powder or nonmagnetic powder with the binder resin component, further improving the dispersion stability of the ferromagnetic metal powder or nonmagnetic powder. Further, lubricants are normally present in a free state. Thus, it is conceivable to use fatty acids with different melting points in the nonmagnetic layer and magnetic layer to control seepage onto the surface, employ esters with different boiling points and polarity to control seepage onto the surface, regulate the quantity of the surfactant to enhance coating stability, and employ a large quantity of lubricant in the nonmagnetic layer to enhance the lubricating effect. All or some part of the additives employed in the present invention can be added in any of the steps during the manufacturing of coating liquids for the magnetic layer and nonmagnetic layer. For example, there are cases where they are mixed with the ferromagnetic powder prior to the kneading step; cases where they are added during the step in which the ferromagnetic powder, binder, and solvent are kneaded; cases where they are added during the dispersion step; cases where they are added after dispersion; and cases where they are added directly before coating.

### Nonmagnetic Layer

Details of the nonmagnetic layer will be described below. The magnetic recording medium of the present invention may comprise a nonmagnetic layer comprising a nonmagnetic powder and a binder between the nonmagnetic support and the magnetic layer. Both organic and inorganic substances may be employed as the nonmagnetic powder in the nonmagnetic layer. Carbon black may also be employed. Examples of inorganic substances are metals, metal oxides, metal carbonates, metal sulfates, metal nitrides, metal carbides, and metal sulfides.

Specifically, titanium oxides such as titanium dioxide, cerium oxide, tin oxide, tungsten oxide, ZnO, ZrO₂, SiO₂, Cr₂O₃, α-alumina with an α-conversion rate of 90 to 100 percent, β-alumina, γ-alumina, α-iron oxide, goethite, corundum, silicon nitride, titanium carbide, magnesium oxide, boron nitride, molybdenum disulfide, copper oxide, MgCO₃, CaCO₃, BaCO₃, SrCO₃, BaSO₄, silicon carbide, and titanium carbide may be employed singly or in combinations of two or more. α-iron oxide and titanium oxide are preferred.

The nonmagnetic powder may be acicular, spherical, polyhedral, or plate-shaped. The crystallite size of the nonmagnetic powder preferably ranges from 4 nm to 500 nm, more preferably from 40 to 100 nm. A crystallite size falling within a range of 4 nm to 500 nm is desirable in that it facilitates dispersion and imparts a suitable surface roughness. The average particle diameter of the nonmagnetic powder preferably ranges from 5 nm to 500 nm. As needed, nonmagnetic powders of differing average particle diameter may be combined; the same effect may be achieved by broadening the average particle distribution of a single nonmagnetic powder. The preferred average particle diameter of the nonmagnetic powder ranges from 10 to 200 nm. Within a range of 5 nm to 500 nm, dispersion is good and good surface roughness can be achieved.

The specific surface area of the nonmagnetic powder preferably ranges from 1 to 150 m²/g, more preferably from 20 to 120 m²/g, and further preferably from 50 to 100 m²/g. Within the specific surface area ranging from 1 to 150 m²/g, suitable surface roughness can be achieved and dispersion is possible with the desired quantity of binder. Oil absorption capacity using dibutyl phthalate (DBP) preferably ranges from 5 to 100 mL/100 g, more preferably from 10 to 80 mL/100 g, and further preferably from 20 to 60 mL/100 g. The specific gravity ranges from, for example, 1 to 12, preferably from 3 to 6. The tap density ranges from, for example, 0.05 to 2 g/mL, preferably from 0.2 to 1.5 g/mL. A tap density falling within a range of 0.05 to 2 g/mL can reduce the amount of scattering particles, thereby facilitating handling, and tends to prevent solidification to the device. The pH of the nonmagnetic powder preferably ranges from 2 to 11, more preferably from 6 to 9. When the pH falls within a range of 2 to 11, the coefficient of friction does not become high at high temperature or high humidity or due to the freeing of fatty acids. The moisture content of the nonmagnetic powder ranges from, for example, 0.1 to 5 weight percent, preferably from 0.2 to 3 weight percent, and more preferably from 0.3 to 1.5 weight percent. A moisture content falling within a range of 0.1 to 5 weight percent is desirable because it can produce good dispersion and yield a stable coating viscosity following dispersion. An ignition loss of equal to or less than 20 weight percent is desirable and nonmagnetic powders with low ignition losses are desirable.

When the nonmagnetic powder is an inorganic powder, the Mohs' hardness is preferably 4 to 10. Durability can be ensured if the Mohs' hardness ranges from 4 to 10. The stearic acid (SA) adsorption capacity of the nonmagnetic powder preferably ranges from 1 to 20 μmol/m², more preferably from 2 to 15 μmol/m². The heat of wetting in 25° C. water of the nonmagnetic powder is preferably within a range of 200 to 600 erg/cm² (approximately 200 to 600 mJ/m²). A solvent with a heat of wetting within this range may also be employed. The quantity of water molecules on the surface at 100 to 400° C. suitably ranges from 1 to 10 pieces per 100 Angstroms. The pH of the isoelectric point in water preferably ranges from 3 to 9. The surface of these nonmagnetic powders is preferably treated with Al₂O₃, SiO₂, TiO₂, ZrO₂, SnO₂, Sb₂O₃, and ZnO. The surface-treating agents of preference with regard to dispersibility are Al₂O₃, SiO₂, TiO₂, and ZrO₂, and Al₂O₃, SiO₂ and ZrO₂ are further preferable. They may be employed singly or in combination. Depending on the objective, a surface-treatment coating layer with a coprecipitated material may also be employed, the coating structure which comprises a first alumina coating and a second silica coating thereover or the reverse structure thereof may also be adopted. Depending on the objective, the surface-treatment coating layer may be a porous layer, with homogeneity and density being generally desirable.

Specific examples of nonmagnetic powders suitable for use in the nonmagnetic layer in the present invention are: Nanotite from Showa Denko K. K.; HIT-100 and ZA-G1 from Sumitomo Chemical Co., Ltd.; DPN-250, DPN-250BX, DPN-245, DPN-270BX, DPN-550BX and DPN-550RX from Toda Kogyo Corp.; titanium oxide TTO-51B, TTO-55A, TTO-55B, TTO-55C, TTO-55S, TTO-55D, SN-100, MJ-7, α-iron oxide E270, E271 and E300 from Ishihara Sangyo Co., Ltd.; STT-4D, STT-30D, STT-30 and STT-65C from Titan Kogyo K. K.; MT-100S, MT-100T, MT-150W, MT-500B, MT-600B, MT-100F and MT-500HD from Tayca Corporation; FINEX-25, BF-1, BF-10, BF-20 and ST-M from Sakai Chemical Industry Co., Ltd.; DEFIC-Y and DEFIC-R from Dowa Mining Co., Ltd.; AS2BM and TiO2P25 from Nippon Aerogil; 100A and 500A from Ube Industries, Ltd.; Y-LOP from Titan Kogyo K. K.; and sintered products of the same. Particular preferable nonmagnetic powders are titanium dioxide and α-iron oxide.

Carbon black may be combined with nonmagnetic powder in the nonmagnetic layer to reduce surface resistivity, reduce light transmittance, and achieve a desired micro-Vickers hardness. The micro-Vickers hardness of the nonmagnetic layer is normally 25 to 60 kg/mm² (approximately 245 to 588 MPa), desirably 30 to 50 kg/mm² (approximately 294 to 490 MPa) to adjust head contact. It can be measured with a thin film hardness meter (HMA-400 made by NEC Corporation) using a diamond triangular needle with a tip radius of 0.1 micrometer and an edge angle of 80 degrees as indenter tip. “Techniques for evaluating thin-film mechanical characteristics,” Realize Corp., for details. The content of the above publication is expressly incorporated herein by reference in its entirety. The light transmittance is generally standardized to an infrared absorbance at a wavelength of about 900 nm equal to or less than 3 percent. For example, in VHS magnetic tapes, it has been standardized to equal to or less than 0.8 percent. To this end, furnace black for rubber, thermal black for rubber, black for coloring, acetylene black and the like may be employed.

The specific surface area of the carbon black employed in the nonmagnetic layer is, for example, 100 to 500 m²/g, preferably 150 to 400 m²/g. The DBP oil absorption capability is, for example, 20 to 400 mL/100 g, preferably 30 to 200 mL/100 g. The particle diameter of the carbon black is, for example, 5 to 80 nm, preferably 10 to 50 nm, and more preferably, 10 to 40 nm. It is preferable that the pH of the carbon black is 2 to 10, the moisture content is 0.1 to 10 percent, and the tap density is 0.1 to 1 g/mL

Specific examples of types of carbon black employed in the nonmagnetic layer are: BLACK PEARLS 2000, 1300, 1000, 900, 905, 800, 880, 700 and VULCAN XC-72 from Cabot Corporation; #3050B, #3150B, #3250B, #3750B, #3950B, #950, #650B, #970B, #850B and MA-600 from Mitsubishi Chemical Corporation; CONDUCTEX SC, RAVEN 8800, 8000, 7000, 5750, 5250, 3500, 2100, 2000, 1800, 1500, 1255 and 1250 from Columbia Carbon Co., Ltd.; and Ketjen Black EC from Ketjen Black International Co., Ltd.

The carbon black employed may be surface-treated with a dispersant or grafted with resin, or have a partially graphite-treated surface. The carbon black may be dispersed in advance into the binder prior to addition to the nonmagnetic coating liquid. These carbon blacks may be used singly or in combination. When employing carbon black, the quantity of the carbon black is preferably within a range not exceeding 50 weight percent of the inorganic powder as well as not exceeding 40 weight percent of the total weight of the nonmagnetic layer. For example, the Carbon Black Handbook compiled by the Carbon Black Association, which is expressly incorporated herein by reference in its entirety, may be consulted for types of carbon black suitable for use in the nonmagnetic layer.

Based on the objective, an organic powder may be added to the nonmagnetic layer. Examples of such an organic powder are acrylic styrene resin powders, benzoguanamine resin powders, melamine resin powders, and phthalocyanine pigments. Polyolefin resin powders, polyester resin powders, polyamide resin powders, polyimide resin powders, and polyfluoroethylene resins may also be employed. The manufacturing methods described in Japanese Unexamined Patent Publication (KOKAI) Showa Nos. 62-18564 and 60-255827 may be employed. The contents of the above applications are expressly incorporated herein by reference in their entirety.

Binders, lubricants, dispersing agents, additives, solvents, dispersion methods, and the like suited to the magnetic layer may be adopted to the nonmagnetic layer. In particular, known techniques for the quantity and type of binder and the quantity and type of additives and dispersion agents employed in the magnetic layer may be adopted thereto.

An undercoating layer can be provided in the magnetic recording medium of the present invention. Providing an undercoating layer can enhance adhesive strength between the support and the magnetic layer or nonmagnetic layer. For example, a polyester resin that is soluble in solvent can be employed as the undercoating layer to enhance adhesion. As described below, a smoothing layer can be provided as an undercoating layer.

### Layer Structure

In the magnetic recording medium of the present invention, the thickness of the nonmagnetic support preferably ranges from 3 to 80 micrometers, more preferably from 3 to 50 micrometers, further preferably from 3 to 10 micrometers. When an undercoating layer is provided between the nonmagnetic support and the nonmagnetic layer or the magnetic layer, the thickness of the undercoating layer ranges from, for example, 0.01 to 0.8 micrometer, preferably 0.02 to 0.6 micrometer.

An intermediate layer can be provided between the support and the nonmagnetic layer or the magnetic layer and/or between the support and the backcoat layer to improve smoothness. For example, the intermediate layer can be formed by coating and drying a coating liquid comprising a polymer on the surface of the nonmagnetic support, or by coating a coating liquid comprising a compound (radiation-curable compound) comprising intramolecular radiation-curable functional groups and then irradiating it with radiation to cure the coating liquid.

A radiation-curable compound having a number average molecular weight ranging from 200 to 2,000 is desirably employed. When the molecular weight is within the above range, the relatively low molecular weight can facilitate coating flow during the calendering step, increasing moldability and permitting the formation of a smooth coating.

A radiation-curable compound in the form of a bifunctional acrylate compound with the molecular weight of 200 to 2,000 is desirable. Bisphenol A, bisphenol F, hydrogenated bisphenol A, hydrogenated bisphenol F, and compounds obtained by adding acrylic acid or methacrylic acid to alkylene oxide adducts of these compounds are preferred.

The radiation-curable compound can be used in combination with a polymeric binder. Examples of the binder employed in combination are conventionally known thermoplastic resins, thermosetting resins, reactive resins, and mixtures thereof. When the radiation employed in the curing process is UV radiation, a polymerization initiator is desirably employed in combination. A known photoradical polymerization initiator, photocationic polymerization initiator, photoamine generator, or the like can be employed as the polymerization initiator.

A radiation-curable compound can also be employed in the nonmagnetic layer.

The thickness of the magnetic layer can be optimized based on the saturation magnetization of the head employed, the length of the head gap, and the recording signal band, and is normally 10 to 150 nm, preferably 20 to 120 nm, more preferably 30 to 100 nm, and further preferably 30 to 80 nm. The thickness variation (σ/δ) in the magnetic layer is preferably within ±50 percent, more preferably within ±30 percent. At least one magnetic layer is sufficient. The magnetic layer may be divided into two or more layers having different magnetic characteristics, and a known configuration relating to multilayered magnetic layer may be applied.

The thickness of the nonmagnetic layer ranges from, for example, 0.1 to 3.0 μm, preferably 0.3 to 2.0 μm, and more preferably 0.5 to 1.5 μm. The nonmagnetic layer of the present invention is effective so long as it is substantially nonmagnetic. For example, it exhibits the effect of the present invention even when it comprises impurities or trace amounts of magnetic material that have been intentionally incorporated, and can be viewed as substantially having the same configuration as the magnetic recording medium of the present invention. The term “substantially nonmagnetic” is used to mean having a residual magnetic flux density in the nonmagnetic layer of equal to or less than 10 mT, or a coercive force Hc of equal to or less than 7.96 kA/m (100 Oe), it being preferable not to have a residual magnetic flux density or coercive force at all.

### Backcoat Layer

A backcoat layer is desirably provided on the surface of the nonmagnetic support, opposite to the surface on which the magnetic layer is provided. The backcoat layer desirably comprises carbon black and inorganic powder. The formula of the magnetic layer or nonmagnetic layer can be applied to the binder and various additives of the backcoat layer. The formula of the nonmagnetic layer is preferred. The backcoat layer is preferably equal to or less than 0.9 micrometer, more preferably 0.1 to 0.7 micrometer, in thickness.

### Manufacturing Method

The process for manufacturing coating liquids for forming magnetic, nonmagnetic and backcoat layers comprises at least a kneading step, a dispersing step, and a mixing step to be carried out, if necessary, before and/or after the kneading and dispersing steps. Each of the individual steps may be divided into two or more stages. All of the starting materials employed in the present invention, including the ferromagnetic powder, nonmagnetic powder, binders, carbon black, abrasives, antistatic agents, lubricants, solvents, and the like, may be added at the beginning of, or during, any of the steps. Moreover, the individual starting materials may be divided up and added during two or more steps. For example, polyurethane may be divided up and added in the kneading step, the dispersion step, and the mixing step for viscosity adjustment after dispersion. To achieve the object of the present invention, conventionally known manufacturing techniques may be utilized for some of the steps. A kneader having a strong kneading force, such as an open kneader, continuous kneader, pressure kneader, or extruder is preferably employed in the kneading step. Details of the kneading process are described in Japanese Unexamined Patent Publication (KOKAI) Heisei Nos. 1-106338 and 1-79274. The contents of these applications are incorporated herein by reference in their entirety. Further, glass beads may be employed to disperse the coating liquids for magnetic, nonmagnetic and backcoat layers, with a dispersing medium with a high specific gravity such as zirconia beads, titania beads, and steel beads being suitable for use. The particle diameter and fill ratio of these dispersing media can be optimized for use. A known dispersing device may be employed. In manufacturing coating liquids, dispersion is preferably enhanced by controlling dispersion conditions (such as types and quantities of beads employed in dispersion, peripheral speed, and dispersion period).

When coating a magnetic recording medium of multilayer configuration, both a wet-on-wet method and a wet-on-dry method can be employed. In the wet-on-wet method, a coating liquid for forming a nonmagnetic layer is coated, and while this coating is still wet, a coating liquid for forming a magnetic layer is coated thereover and dried. In the wet-on-dry method, a coating liquid for forming a nonmagnetic layer is coated and dried to form a nonmagnetic layer, and then a coating liquid for forming a magnetic layer is coated on the nonmagnetic layer and dried.

When using the wet-on-wet method, the following methods are desirably employed;

(1) a method in which the nonmagnetic layer is first coated with a coating device commonly employed to coat magnetic coating materials such as a gravure coating, roll coating, blade coating, or extrusion coating device, and the magnetic layer is coated while the nonmagnetic layer is still wet by means of a support pressure extrusion coating device such as is disclosed in Japanese Examined Patent Publication (KOKOKU) Heisei No. 1-46186 and Japanese Unexamined Patent Publication (KOKAI) Showa No. 60-238179 and Japanese Unexamined Patent Publication (KOKAI) Heisei No. 2-265672, which are expressly incorporated herein by reference in their entirety;

(2) a method in which the upper and lower layers are coated nearly simultaneously by a single coating head having two built-in slits for passing coating liquid, such as is disclosed in Japanese Unexamined Patent Publication (KOKAI) Showa No. 63-88080, Japanese Unexamined Patent Publication (KOKAI) Heisei No. 2-17971, and Japanese Unexamined Patent Publication (KOKAI) Heisei No. 2-265672, which are expressly incorporated herein by reference in their entirety; and

(3) a method in which the upper and lower layers are coated nearly simultaneously using an extrusion coating apparatus with a backup roller as disclosed in Japanese Unexamined Patent Publication (KOKAI) Heisei No. 2-174965, which is expressly incorporated herein by reference in its entirety. To avoid deteriorating the electromagnetic characteristics or the like of the magnetic recording medium by aggregation of magnetic particles, shear is desirably imparted to the coating liquid in the coating head by a method such as disclosed in Japanese Unexamined Patent Publication (KOKAI) Showa No. 62-95174 or Japanese Unexamined Patent Publication (KOKAI) Heisei No. 1-236968, which are expressly incorporated herein by reference in their entirety. In addition, the viscosity of the coating liquid preferably satisfies the numerical range specified in Japanese Unexamined Patent Publication (KOKAI) Heisei No. 3-8471, which are expressly incorporated herein by reference in its entirety.

Coating of coating liquid for each layer can be carried out with a coating device commonly employed to coat magnetic coating materials such as a gravure coating, roll coating, blade coating, or extrusion coating device.

When the magnetic recording medium of the present invention is a magnetic tape, the coating layer that is formed by applying the magnetic layer coating liquid can be magnetic field orientation processed using cobalt magnets or solenoids on the ferromagnetic powder contained in the coating layer. When it is a disk, an adequately isotropic orientation can be achieved in some products without orientation using an orientation device, but the use of a known random orientation device in which cobalt magnets are alternately arranged diagonally, or alternating fields are applied by solenoids, is desirable. In the case of ferromagnetic metal powder, the term “isotropic orientation” generally refers to a two-dimensional in-plane random orientation, which is desirable, but can refer to a three-dimensional random orientation achieved by imparting a perpendicular component. Further, a known method, such as opposing magnets of opposite poles, can be employed to effect perpendicular orientation, thereby imparting an isotropic magnetic characteristic in the peripheral direction. Perpendicular orientation is particularly desirable when conducting high-density recording. Spin coating can be used to effect peripheral orientation.

The drying position of the coating is desirably controlled by controlling the temperature and flow rate of drying air, and coating speed. A coating speed of 20 m/min to 1,000 m/min and a dry air temperature of equal to or higher than 60° C. are desirable. Suitable predrying can be conducted prior to entry into the magnet zone.

The coated stock material thus obtained can be temporarily wound on a take-up roll, and then unwound from the take-up roll and calendered.

For example, super calender rolls can be employed in calendering. Calendering can enhance surface smoothness, eliminate voids produced by the removal of solvent during drying, and increase the fill rate of the ferromagnetic powder in the magnetic layer, thus yielding a magnetic recording medium of good electromagnetic characteristics. The calendering step is desirably conducted by varying the calendering conditions in response to the smoothness of the surface of the coated stock material.

The glossiness of the coated stock material may decrease roughly from the center of the take-up roll toward the outside, and there is sometimes variation in the quality in the longitudinal direction. Glossiness is known to correlate (proportionally) to the surface roughness Ra. Accordingly, when the calendering conditions are not varied in the calendering step, such as by maintaining a constant calender roll pressure, there is no countermeasure for the difference in smoothness in the longitudinal direction resulting from winding of the coated stock material, and the variation in quality in the lengthwise direction tends to carry over into the final product.

Accordingly, in the calendering step, it is desirable to vary the calendering conditions, such as the calender roll pressure, to cancel out the different in smoothness in the longitudinal direction that is produced by winding of the coated stock material. Specifically, it is desirable to reduce the calender roll pressure from the center to the outside of the coated stock material that is wound off the take-up roll. Based on an investigation by the present inventors, lowering the calender roll pressure decreases the glossiness (smoothness diminishes). Thus, the difference in smoothness in the longitudinal direction that is produced by winding of the coated stock material is cancelled out, yielding a final product free of variation in quality in the longitudinal direction.

An example of changing the pressure of the calender rolls has been described above. Additionally, it is possible to control the calender roll temperature, calender roll speed, and calender roll tension. Taking into account the properties of a particulate medium, it is desirable to control the surface smoothness by means of the calender roll pressure and calender roll temperature. Generally, the calender roll pressure is reduced, or the calender roll temperature is lowered, to diminish the surface smoothness of the final product. Conversely, the calender roll pressure can be increased or the calender roll temperature can be raised to increase the surface smoothness of the final product.

Rolls of a heat-resistant plastic such as epoxy, polyimide, polyamide, or polyamidoimide, can be employed as the calender rolls. Processing with metal rolls is also possible.

As for the calendaring conditions, the calender roll temperature ranges from, for example, 60 to 100° C., preferably 70 to 100° C., and more preferably 80 to 100° C. The pressure ranges from, for example, 100 to 500 kg/cm (98 to 490 kN/m), preferably 200 to 450 kg/cm (196 to 441 kN/m), and more preferably 300 to 400 kg/cm (294 to 392 kN/m).

The magnetic recording medium obtained can be cut to desired size with a cutter or the like. The cutter is not specifically limited, but desirably comprises multiple sets of a rotating upper blade (male blade) and lower blade (female blade). The slitting speed, engaging depth, peripheral speed ratio of the upper blade (male blade) and lower blade (female blade) (upper blade peripheral speed/lower blade peripheral speed), period of continuous use of slitting blade, and the like are suitably selected.

### Physical Characteristics

The saturation magnetic flux density of the magnet layer is preferably 100 to 400 mT. The coercivity (Hc) of the magnetic layer is preferably 143.2 to 318.3 kA/m (approximately 1,800 to 4,000 Oe), more preferably 159.2 to 278.5 kA/m (approximately 2,000 to 3,500 Oe). Narrower coercivity distribution is preferable. The SFD and SFDr are preferably equal to or lower than 0.6, more preferably equal to or lower than 0.3.

The coefficient of friction of the magnetic recording medium relative to the head is, for example, equal to or less than 0.5 and preferably equal to or less than 0.3 at temperatures ranging from −10° C. to 40° C. and humidity ranging from 0 percent to 95 percent, the surface resistivity on the magnetic surface preferably ranges from 10⁴ to 10⁸ ohm/sq, and the charge potential preferably ranges from −500 V to +500 V. The modulus of elasticity at 0.5 percent extension of the magnetic layer preferably ranges from 0.98 to 19.6 GPa (approximately 100 to 2,000 kg/mm²) in each in-plane direction. The breaking strength preferably ranges from 98 to 686 MPa (approximately 10 to 70 kg/mm²). The modulus of elasticity of the magnetic recording medium preferably ranges from 0.98 to 14.7 GPa (approximately 100 to 1506 kg/mm²) in each in-plane direction. The residual elongation is preferably equal to or less than 0.5 percent, and the thermal shrinkage rate at all temperatures below 100° C. is preferably equal to or less than 1 percent, more preferably equal to or less than 0.5 percent, and most preferably equal to or less than 0.1 percent.

The glass transition temperature (i.e., the temperature at which the loss elastic modulus of dynamic viscoelasticity peaks as measured at 110 Hz with a dynamic viscoelastometer, such as RHEOVIBRON made by A&D Co. Ltd) of the magnetic layer preferably ranges from 50 to 180° C., and that of the nonmagnetic layer preferably ranges from 0 to 180° C. The loss elastic modulus preferably falls within a range of 1×10⁷ to 8×10⁸ Pa (approximately 1×10⁸ to 8×10⁹ dyne/cm²) and the loss tangent is preferably equal to or less than 0.2. Adhesion failure tends to occur when the loss tangent becomes excessively large. These thermal characteristics and mechanical characteristics are desirably nearly identical, varying by equal to or less than 10 percent, in each in-plane direction of the medium.

The residual solvent contained in the magnetic layer is preferably equal to or less than 100 mg/m² and more preferably equal to or less than 10 mg/m². The void ratio in the coated layers, including both the nonmagnetic layer and the magnetic layer, is preferably equal to or less than 40 volume percent, more preferably equal to or less than 30 volume percent. Although a low void ratio is preferable for attaining high output, there are some cases in which it is better to ensure a certain level based on the object. For example, in many cases, larger void ratio permits preferred running durability in disk media in which repeat use is important.

Physical properties of the nonmagnetic layer and magnetic layer may be varied based on the objective in the magnetic recording medium of the present invention. For example, the modulus of elasticity of the magnetic layer may be increased to improve running durability while simultaneously employing a lower modulus of elasticity than that of the magnetic layer in the nonmagnetic layer to improve the head contact of the magnetic recording medium.

### EXAMPLES

The present invention will be described in detail below based on examples. However, the present invention is not limited to the examples. The term “parts” given in Examples are weight parts unless specifically stated otherwise.

### Example 1

1. Preparation of Magnetic Layer Coating Liquid

One hundred parts of ferromagnetic metal powder (Co/Fe=40 atomic percent; Hc: 2,200 Oe (approximately 175 kA/m); S_{BET}: 75 m²/g; surface treatment layer: Al₂O₃, Y₂O₃; mean major axis length: 35 nm; mean acicular ratio: 4; σs: 110 A·m²/kg (approximately 110 emu/g)) were comminuted for 10 minutes in an open kneader. The following were then added:

| | | |
|---|---|---|
| carbon black (average particle diameter: 80 nm) | 2 | parts, |
| vinyl chloride resin (MR-110, made by Nippon Zeon Co., Ltd.) | 10 | parts, |
| polyester polyurethane (UR8300, made by Toyobo Co., Ltd.) | 10 | parts (solid component), |
| and | | |
| methyl ethyl ketone/cyclohexanone = 1/1 | 60 | parts, |
| and the mixture was kneaded for 60 minutes. While working the kneaded product in | | |
| an open kneader, | | |
| methyl ethyl ketone/cyclohexanone = 1/1 | 200 | parts |
| were added over 6 hours. Next, | | |
| α-Al₂O₃ dispersion | 20 | parts |
| were added and the mixture was dispersed for 120 minutes in a sand grinder. Further, | | |
| polyisocyanate (Coronate 3041, made by Nippon Polyurethane Co., Ltd.) | 5 | parts (solid component), |
| stearic acid | 1 | part, |
| the carbonic ester shown in Table 1 | 1 | part, |
| stearic acid amide | 0.2 | part, |
| and | | |
| toluene | 50 | parts |
| were added and the mixture was stirred for 20 minutes. Subsequently, the mixture was | | |
| filtered with a filter having a mean pore size of 1 micrometer to prepare the magnetic | | |
| layer coating liquid. | | |

2. Preparation of Nonmagnetic Layer Coating Liquid

| Eighty-five parts of α-iron oxide (average particle diameter: 0.15 micrometer, | | |
|---|---|---|
| tap density: 0.8 g/mL, acicular ratio: 7, pH: 8, DBP oil absorption capability: 33 g/100 g, | | |
| surface treatment layers: Al₂O₃ and SiO₂, S_{BET}: 52 m²/g) and | | |
| carbon black (Ketjen Black EC, made by Ketjen Black International Co., Ltd.) | 20 | parts |
| were comminuted for 10 minutes in an open kneader. Subsequently, | | |
| vinyl chloride copolymer (MR110, made by Z Nippon Zeon Co., Ltd.) | 10 | parts, |
| sulfonic acid-containing polyurethane resin (UR8200 made by Toyobo Co., | 10 | parts (solid component), |
| Ltd.) | | |
| and | | |
| cyclohexanone | 60 | parts |
| were added and the mixture was kneaded for 60 minutes. Next, | | |
| methyl ethyl ketone/cyclohexanone = 6/4 | 200 | parts |
| were added and the mixture was dispersed in a sand mill for 120 minutes. To the | | |
| mixture were then added: | | |
| polyisocyanate (Coronate 3041 made by Nippon Polyurethane Co., Ltd.) | 5 | parts (solid component), |
| stearic acid (see Table 1) | 1 | part, |
| the carbonic ester indicated below (see Table 1) | 1 | part, |
| and | | |
| methyl ethyl ketone | 50 | parts. |

When the mixture had been further stirred for 20 minutes, it was filtered with a filter having a mean pore size of 1 micrometer to prepare the nonmagnetic layer coating liquid.

### Carbonic Ester Employed in Example 1

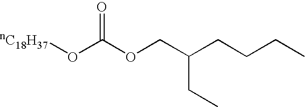

3. Preparation of Magnetic Tape

The nonmagnetic layer coating liquid obtained was coated in a quantity calculated to yield a dry thickness of 1.0 micrometer, and immediately thereafter, the magnetic layer coating liquid was coated in a quantity calculated to yield a dry thickness of 0.1 micrometer, to the surface of a polyethylene naphthalate support 5 micrometer in thickness in a simultaneous multilayer coating (wet-on-wet). While the magnetic layer coating liquid was still wet, magnetic field orientation was conducted with 0.5 T (approximately 5,000 Gauss) Co magnets and 0.4 T (approximately 4,000 Gauss) solenoid magnets, and the solvent was dried. The product was then calendered twice with a combination comprised of seven stages of metal rolls at a speed of 50 m/min, a linear pressure of 300 kg/cm, and a temperature of 95° C., sliced to a width of ½ inch, and inserted into a cartridge of IBM 3592 extended-capacity format.

### Example 2

With the exception that the carbonic ester contained in the magnetic layer and nonmagnetic layer was changed to the carbonic ester indicated below (where R² in general formula (1) denotes linear C₁₆H₃₃), a cartridge was prepared by the same method as in Example 1.

### Carbonic Ester Employed in Example 2

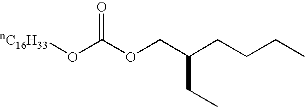

### Example 3

With the exception that the carbonic ester contained in the magnetic layer and nonmagnetic layer was changed to the carbonic ester indicated below (where R² in general formula (1) denotes linear C₁₄H₂₉), a cartridge was prepared by the same method as in Example 1.

### Carbonic Ester Employed in Example 3

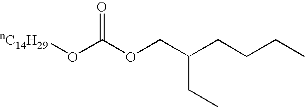

### Example 4

A cartridge was prepared by the same method as in Example 1 with the exception that in the carbonic ester employed in the magnetic layer and nonmagnetic layer, while R² in general formula (1) was identical to that in the carbonic ester employed in Example 1, R¹ was changed from 2-ethylhexyl to 2-methylbutyl.

### Example 5

A cartridge was prepared by the same method as in Example 1 with the exception that in the carbonic ester employed in the magnetic layer and nonmagnetic layer, while R² in general formula (1) was identical to that in the carbonic ester employed in Example 1, R¹ was changed from 2-ethylhexyl to 2-methylpropyl.

### Example 6

With the exception that the dispersion period during preparation of the magnetic layer coating liquid was changed to 240 minutes and only a single calendering treatment was conducted, a cartridge was prepared by the same method as in Example 1.

### Comparative Example 1

With the exception that the carbonic ester employed in the magnetic layer and nonmagnetic layer was changed to sec-butyl stearate (fatty ester), a cartridge was prepared by the same method as in Example 1.

### Comparative Example 2

With the exception that the carbonic ester employed in the magnetic layer and nonmagnetic layer was changed to 2-ethylhexyl stearate (fatty ester), a cartridge was prepared by the same method as in Example 1.

### Comparative Example 3

With the exception that the carbonic ester employed in the magnetic layer and nonmagnetic layer was changed to the carbonic ester indicated below (where R² in general formula (1) denotes linear C₁₂H₂₅), a cartridge was prepared by the same method as in Example 1.

### Carbonic Ester Employed in Comparative Example 3

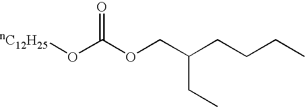

### Comparative Example 4

A cartridge was prepared by the same method as in Example 1 with the exception that in the carbonic ester employed in the magnetic layer and nonmagnetic layer, while R¹ in general formula (1) was identical to that in the carbonic ester employed in Example 1, R² was changed to linear C₂₂H₄₅.

### Comparative Example 5

With the exception that the dispersion period in the sand grinder during the preparation of the magnetic layer coating liquid was shortened to 60 minutes, a cartridge was prepared by the same method as in Example 1.

### Comparative Example 6

With the exception that the dispersion period in the sand grinder during the preparation of the magnetic layer coating liquid was lengthened to 180 minutes, a cartridge was prepared by the same method as in Example 1.

### Comparative Example 7

With the exception that the calendering temperature was changed to 70° C. and the number of calendering treatments was changed to one, a cartridge was prepared by the same method as in Example 1.

### Comparative Example 8

With the exception that the calendering temperature was changed to 95° C. and the number of calendering treatments was changed to three, a cartridge was prepared by the same method as in Example 1.

### Comparative Example 9

A cartridge was prepared by the same method as in Example 1 with the exception that in the carbonic ester employed in the magnetic layer and nonmagnetic layer, while R² in general formula (1) was identical to that in the carbonic ester employed in Example 3, R² was changed from 2-ethylhexyl to 2-methylbutyl.

### Comparative Example 10

A cartridge was prepared by the same method as in Example 1 with the exception that in the carbonic ester employed in the magnetic layer and nonmagnetic layer, R¹ in general formula (1) was changed from 2-ethylhexyl to butyl in the carbonic ester employed in Example 1, and R² was changed to linear C₁₄H₂₉.

### Evaluation of Magnetic Tape

(1) Measurement of the Average Surface Roughness Ra of Magnetic Layer

The Ra of a 40 micrometer square on the surface of the magnetic tape prior to insertion into the cartridge was measured with an SPI 3800 N made by SII NanoTechnology, Inc.

(2) Indentation Hardness of Magnetic Layer

Using a microindentation tester (the ENT-1100a made by Elionix Co.), the hardness was measured by pressing a diamond indenter into the magnetic layer surface with a load of 6 mgf in a 25° C. environment.

The results of the above are given in Table 1.

### Evaluation of Running Durability and the Renewed Running Property

An Enterprise Tape Drive 3592 made by IBM was employed in the evaluation. For running durability, extended durability running was conducted in an environment of 40° C. and 80 percent RH and the C1 error rate was measured at 300 ffp. For the renewed running property, after running 300 ffp, the tape and head were left in a state of contact for 24 hours and the degree of sticking of the tape during subsequent renewed running was visually observed.

The results of the above are given in Table 2.

TABLE 1

| | Carbonic ester or fatty ester | | |
|---|---|---|---|
| | R¹ in general | R² in general | |
| | formula (1) | formula (1) | |
| | (For Comp. Ex., | (For Comp. Ex., | |
| | the portion | the portion | |
| | corresponding to | corresponding to | |
| | R¹) | R²) | Molecular weight |
| Example 1 | 2-ethylhexyl | octadecyl | 426 |
| Example 2 | 2-ethylhexyl | hexadecyl | 398 |
| Example 3 | 2-ethylhexyl | tetradecyl | 370 |
| Example 4 | 2-methylbutyl | octadecyl | 384 |
| Example 5 | 2-methylpropyl | octadecyl | 370 |
| Example 6 | 2-ethylhexyl | octadecyl | 426 |
| Comp. Ex. 1 | sec-butyl stearate (fatty ester) | | 340 |
| Comp. Ex. 2 | 2-ethylhexyl stearate (fatty ester) | | 396 |
| Comp. Ex. 3 | 2-ethylhexyl | dodecyl | 342 |
| Comp. Ex. 4 | 2-ethylhexyl | docosyl | 482 |
| Comp. Ex. 5 | 2-ethylhexyl | octadecyl | 426 |
| Comp. Ex. 6 | 2-ethylhexyl | octadecyl | 426 |
| Comp. Ex. 7 | 2-ethylhexyl | octadecyl | 426 |
| Comp. Ex. 8 | 2-ethylhexyl | octadecyl | 426 |
| Comp. Ex. 9 | 2-methylbutyl | tetradecyl | 328 |
| Comp. Ex. 10 | butyl | octadecyl | 370 |

| | Surface roughness | |
|---|---|---|
| | AFM Ra (nm) | Indentation hardness |
| Example 1 | 2.3 | 0.62 GPa (63 kg/mm²) |
| Example 2 | 2.8 | 0.61 GPa (62 kg/mm²) |
| Example 3 | 2.7 | 0.61 GPa (62 kg/mm²) |
| Example 4 | 2.7 | 0.62 GPa (63 kg/mm²) |
| Example 5 | 2.5 | 0.62 GPa (63 kg/mm²) |
| Example 6 | 2.8 | 0.51 GPa (52 kg/mm²) |
| Comp. Ex. 1 | 2.7 | 0.60 GPa (61 kg/mm²) |
| Comp. Ex. 2 | 2.5 | 0.56 GPa (57 kg/mm²) |
| Comp. Ex. 3 | 2.7 | 0.63 GPa (64 kg/mm²) |
| Comp. Ex. 4 | 2.3 | 0.61 GPa (62 kg/mm²) |
| Comp. Ex. 5 | 3.8 | 0.58 GPa (59 kg/mm²) |
| Comp. Ex. 6 | 1.8 | 0.62 GPa (63 kg/mm²) |
| Comp. Ex. 7 | 2.9 | 0.45 GPa (46 kg/mm²) |
| Comp. Ex. 8 | 2.5 | 0.82 GPa (84 kg/mm²) |
| Comp. Ex. 9 | 2.5 | 0.63 GPa (64 kg/mm²) |
| Comp. Ex. 10 | 2.6 | 0.63 GPa (64 kg/mm²) |

TABLE 2

| | Running durability | |
|---|---|---|
| | error rate | Renewed running property |
| | 40° C., 80% RH, 300ffp | degree of sticking |
| Example 1 | Excellent: 2E−6 | Excellent: Smooth running |
| Example 2 | Excellent: 3E−6 | Excellent: Smooth running |
| Example 3 | Excellent: 2E−6 | Good: Little sticking |
| Example 4 | Excellent: 3E−6 | Excellent: Smooth running |
| Example 5 | Excellent: 3E−6 | Good: Little sticking |
| Example 6 | Good: 8E−6 | Good: Little sticking |
| Comp. Ex. 1 | Poor: 4E−4 | Poor: Sticking |
| Comp. Ex. 2 | Poor: 7E−4 | Excellent: Smooth running |
| Comp. Ex. 3 | Excellent: 7E−6 | Poor: sticking |
| Comp. Ex. 4 | Poor: 6E−2 | — |
| Comp. Ex. 5 | Poor: 6E−3 | Excellent: Smooth running |
| Comp. Ex. 6 | Poor: 1E−4 | — |
| Comp. Ex. 7 | Good: 3E−5 | Poor: Sticking |
| Comp. Ex. 8 | Poor: 3E−4 | Excellent: Smooth running |
| Comp. Ex. 9 | Excellent: 6E−6 | Poor: Sticking |
| Comp. Ex. 10 | Poor: 1E−4 | — |

### Evaluation Results

Examples 1 to 6 all exhibited good running durability and renewed running properties.

By contrast, Comparative Example 1 exhibited poor running durability and a poor renewed running property. Running durability deteriorated due to hydrolysis resulting from the use of fatty ester. The poor renewed running property was attributed to the seepage of a large quantity of low-molecular-weight fatty ester onto the magnetic layer surface during the period (24 hours) during which the head was in contact with the tape.

Comparative Example 2 exhibited poor running durability, which was attributed to hydrolysis due to the use of fatty ester in the same manner as in Comparative Example 1. The poor renewed running property of Comparative Examples 3 and 9 was attributed to the seepage of large quantities of low-molecular-weight carbonic ester onto the magnetic layer surface during storage.

In Comparative Example 4, high-molecular-weight carbonic acid was employed. Thus, clogging occurred due to the precipitation of the fatty ester, diminishing running durability. Since the clogging was severe, renewed running evaluation was not conducted.

In Comparative Example 5, deterioration of the surface smoothness of the magnetic layer prevented the achievement of a good error rate. Renewed running evaluation was good.

In Comparative Example 6, the surface smoothness of the magnetic layer was excessively high. This resulted in an increased frictional coefficient and failed head contact. Thus, running durability was deteriorated. Due to the high frictional coefficient, renewed running evaluation was not conducted.

In Comparative Example 7, the renewed running property deteriorated due to low indentation hardness of the magnetic layer. By contrast, in Comparative Example 8, excessively high indentation hardness of the magnetic layer resulted in failed head contact, making it impossible to achieve a good error rate.

In Comparative Example 9, the molecular weight of the carbonic ester employed was less than 360. Thus, when the head and tape were in contact, lubricant tended to seep onto the tape surface from the layers, resulting in sticking during renewed running.

In Comparative Example 10, running durability deteriorated. This was presumed to have occurred because the portion of the carbonic ester corresponding to R¹ in general formula (1) was a linear alkyl, resulting in a high melting point and thus a high frictional coefficient. Accordingly, no renewed running evaluation was conducted.

The magnetic recording medium of the present invention is suitable for use in high-density recording in which running durability and long-term storage capability are required, such as in backup tapes.

Although the present invention has been described in considerable detail with regard to certain versions thereof, other versions are possible, and alterations, permutations and equivalents of the version shown will become apparent to those skilled in the art upon a reading of the specification and study of the drawings. Also, the various features of the versions herein can be combined in various ways to provide additional versions of the present invention. Furthermore, certain terminology has been used for the purposes of descriptive clarity, and not to limit the present invention. Therefore, any appended claims should not be limited to the description of the preferred versions contained herein and should include all such alterations, permutations, and equivalents as fall within the true spirit and scope of the present invention.

Having now fully described this invention, it will be understood to those of ordinary skill in the art that the methods of the present invention can be carried out with a wide and equivalent range of conditions, formulations, and other parameters without departing from the scope of the invention or any embodiments thereof.

All patents and publications cited herein are hereby fully incorporated by reference in their entirety. The citation of any publication is for its disclosure prior to the filing date and should not be construed as an admission that such publication is prior art or that the present invention is not entitled to antedate such publication by virtue of prior invention.

Unless otherwise stated, a reference to a compound or component includes the compound or component by itself, as well as in combination with other compounds or components, such as mixtures of compounds.

As used herein, the singular forms “a,” “an,” and “the” include the plural reference unless the context clearly dictates otherwise.

Except where otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not to be considered as an attempt to limit the application of the doctrine of equivalents to the scope of the claims, each numerical parameter should be construed in light of the number of significant digits and ordinary rounding conventions.

Additionally, the recitation of numerical ranges within this specification is considered to be a disclosure of all numerical values and ranges within that range. For example, if a range is from about 1 to about 50, it is deemed to include, for example, 1, 7, 34, 46.1, 23.7, or any other value or range within the range.

What is claimed is:

1. A magnetic recording medium comprising a magnetic layer comprising a ferromagnetic powder and a binder on a nonmagnetic support, wherein
the magnetic layer has an average surface roughness Ra, measured by an atomic force microscope, ranging from 2.0 to 3.5 nm and an indentation hardness ranging from 0.49 GPa to 0.78 GPa, as well as further comprises a carbonic ester having a molecular weight of 360 to 460 that is denoted by general formula (1) 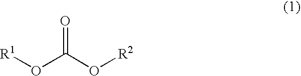
[In general formula (1), R¹ denotes a saturated hydrocarbon group having a branched structure, and R² denotes a saturated hydrocarbon group having a linear structure with 14 to 20 carbon atoms.]

2. The magnetic recording medium according to claim 1, wherein R¹ denotes a saturated hydrocarbon group having a branched structure at a β position.

3. The magnetic recording medium according to claim 1, wherein R¹ denotes 2-methylpropyl group, 2-methylbutyl group, or 2-ethylhexyl group.

4. The magnetic recording medium according to claim 1, wherein R² denotes a saturated hydrocarbon group having a linear structure with 14 to 18 carbon atoms.

5. The magnetic recording medium according to claim 1, wherein R² denotes tetradecyl group, hexadecyl group, or octadecyl group.

6. The magnetic recording medium according to claim 1, which has a nonmagnetic layer comprising a nonmagnetic powder and a binder between the nonmagnetic support and the magnetic layer, and the nonmagnetic layer comprises the carbonic ester.
